(19) United States
(12) Patent Application Publication
(10) Pub. No.: US 2018/0309220 A1
(43) Pub. Date: Oct. 25, 2018

(54) Multi-Contact Connector

(71) Applicant: IRISO ELECTRONICS CO., LTD., Kanagawa (JP)

(72) Inventor: Yoshiyuki Ogura, Kanagawa (JP)

(73) Assignee: IRISO ELECTRONICS CO., LTD., Kanagawa (JP)

(21) Appl. No.: 15/924,485

(22) Filed: Mar. 19, 2018

(30) Foreign Application Priority Data
Mar. 30, 2017 (JP) 2017-066932

(51) Int. Cl. H01R 13/41; H01R 12/73; H01R 12/57; H01R 13/26

(52) U.S. Cl. CPC H01R 13/41; H01R 13/26; H01R 12/57; H01R 12/737

(57) ABSTRACT

An object is to reduce the size of a multi-contact connector having a wiping function. A multi-contact connector includes a front terminal and a rear terminal. The front terminal and the rear terminal are independently housed in one terminal accommodating groove in a housing in such a manner as to separate from each other. Unlike terminals of a multi-contact connector according to the related art, each terminal has no junction where it divides into a front contact and a rear contact. The housing requires no space for accommodating such a junction, and this reduces the size of the multi-contact connector.

### BACKGROUND OF THE INVENTION

### 1. Field of the Invention

The present invention relates to a multi-contact connector in which a front contact of a front terminal and a rear contact of a rear terminal are configured to contact a connection object.

### 2. Description of the Related Art

Connection reliability is a fundamental characteristic required for connectors. To improve connection reliability, multi-contact connectors have been developed, which include a front terminal with a front contact and a rear terminal with a rear contact and have a wiping function of wiping off foreign matter (see Japanese Unexamined Patent Application Publication No. 2001-23711 (e.g., FIGS. 2, 3, and 8), Japanese Unexamined Patent Application Publication No. 2016-173998 (e.g., FIGS. 1 and 4), and Japanese Examined Patent Application Publication No. 47-41714 (e.g., FIGS. 11 to 13)). A multi-contact connector is configured in such a manner that after the front contact of the front terminal contacts a connection object, the rear contact of the rear terminal located on a line extending from the front contact in the insertion direction of the connection object contacts the connection object. This means that the rear contact contacts the connection object after the front contact removes foreign matter adhering to the connection object. It is thus possible to achieve a highly reliable electrical connection.

Examples of the terminal structure including the front contact and the rear contact are described in Japanese Unexamined Patent Application Publication No. 2001-23711 and Japanese Unexamined Patent Application Publication No. 2016-173998. In these examples, each terminal has a junction where it bends in the middle thereof in the longitudinal direction and divides into a front contact and a rear contact. In this terminal structure, the presence of junctions increases the size of terminals, and thus increases the size of the multi-contact connector which houses the terminals. It is difficult to reduce the size of the junctions, which are typically produced by bending in the molding process.

Another terminal structure is described in Japanese Examined Patent Application Publication No. 47-41714. In this example, a front terminal with a front contact and a rear terminal with a rear contact, which are provided separately, are combined together to form a single terminal. Manufacturing this terminal requires the step of combining together the front terminal and the rear terminal, which are separate components. The assembly process which involves combining the front terminal and the rear terminal together tends to cause variation in the dimensional accuracy of the resulting terminal and this make it difficult to achieve a size reduction.

### SUMMARY OF THE INVENTION

The present invention has been made on the background of the related art described above. An object of the present invention is to reduce the size of a multi-contact connector having a wiping function.

To achieve the object described above, the present invention is configured as one having the following features.

That is, the present invention provides a multi-contact connector including a housing having a fitting chamber into which a connection object is to be inserted; a front terminal including a flat plate-like front extending portion held by the housing, and a front contact configured to contact the connection object inserted into the fitting chamber; and a rear terminal including a flat plate-like rear extending portion held by the housing, and a rear contact located on a line extending from the front contact in an insertion direction of the connection object. The housing has one terminal accommodating groove communicating with the fitting chamber and configured to accommodate the front terminal and the rear terminal together in such a manner that the front terminal and the rear terminal are in a separate state. The front terminal and the rear terminal include respective substrate connecting portions extending from the terminal accommodating groove and electrically connected to one circuit contact point on a substrate.

In the multi-contact connector described above, after the front contact of the front terminal contacts the connection object, the rear contact of the rear terminal located on the line extending from the front contact in the insertion direction of the connection object contacts the connection object. Thus, since the rear contact contacts the connection object after the front contact removes foreign matter adhering to the connection object, a highly reliable electrical connection is achieved.

Also, the front terminal and the rear terminal are independently housed in one terminal accommodating groove in the housing in such a manner as to separate from each other. Unlike in the case of a multi-contact connector of the related art in which each terminal extending from the proximal side divides into a front contact and a rear contact at a junction in the middle thereof, the housing requires no space for accommodating such a junction, and this reduces the size of the multi-contact connector. Additionally, the terminal structure without such a junction is simple and easy to manufacture.

Also, the front terminal and the rear terminal include respective substrate connecting portions extending from the terminal accommodating groove and electrically connected to one circuit contact point on the substrate. The substrate connecting portion of the front terminal and the substrate connecting portion of the rear terminal are thus independently electrically connected to one circuit contact point. Therefore, even if the substrate connecting portion of one of the front and rear terminals fails to make contact with the circuit contact point, the other substrate connecting portion can maintain the electrical connection and this makes it possible to maintain high connection reliability. As described above, the substrate connecting portion of the front terminal and the substrate connecting portion of the rear terminal are electrically connected to one circuit contact point. Such an electrical connection is made, for example, by soldering. Since the substrate connecting portions of the front and rear terminals can be soldered together, the peeling strength of the soldering portion can be improved.

According to an aspect of the present invention, the substrate connecting portion of the front terminal and the substrate connecting portion of the rear terminal may each include a contact portion soldered to the circuit contact point and a leg extending from the terminal accommodating groove to the contact portion. The leg of the front terminal and the leg of the rear terminal may partly extend in directions different from each other.

Ideally, the connection object is inserted in a straight line into the fitting chamber. However, the connection object is often inserted at an angle in a three-dimensional direction into the fitting chamber, and insertion forces of the connection object from various directions act on the multi-contact connector. If the leg of the front terminal and the leg of the rear terminal have the same shape, all the legs deform in the same way and this makes it difficult for the legs to accommodate the insertion forces from various directions. This may result in concentration of stress on the soldering portion that secures the contact portions to the circuit contact point, and may produce defects, such as cracks.

In the front terminal and the rear terminal according to the aspect of the present invention described above, however, the leg of the front terminal and the leg of the rear terminal partly extend in directions different from each other. Therefore, even if the connection object is inserted at an angle, at least one of the legs partly extending in different directions stretches to accommodate the insertion force. This relieves the insertion force acting on the soldering portion.

According to another aspect of the present invention, the terminal accommodating groove may be configured to accommodate the front terminal and the rear terminal in such a manner that a flat surface of the front extending portion and a flat surface of the rear extending portion extend along a width direction of the terminal accommodating groove and face each other.

The terminal accommodating groove according to this aspect of the present invention is configured to accommodate the front terminal and the rear terminal in such a manner that the flat surface of the front extending portion and the flat surface of the rear extending portion extend along the width direction of the terminal accommodating groove and face each other. This makes the multi-contact connector smaller in size than the multi-contact connector in which the terminal accommodating groove accommodates the front terminal and the rear terminal in such a manner that the flat surface of the front extending portion and the flat surface of the rear extending portion are arranged side by side, in their surface direction, along the depth or width direction of the terminal accommodating groove.

According to another aspect of the present invention, the terminal accommodating groove may have a rear-terminal securing groove and a front-terminal securing groove. The rear-terminal securing groove is disposed adjacent to an opening of the terminal accommodating groove communicating with the fitting chamber, and is configured to allow the rear extending portion to be press-fitted thereinto in such a manner that a surface of the rear extending portion extends along a width direction of the terminal accommodating groove. The front-terminal securing groove is disposed closer to a bottom surface of the terminal accommodating groove than the rear-terminal securing groove is, and is configured to allow the front extending portion to be press-fitted thereinto in such a manner that a surface of the front extending portion extends along the width direction of the terminal accommodating groove.

In the housing according to this aspect of the present invention, the front extending portion is press-fitted into and secured to the front-terminal securing groove and the rear extending portion is press-fitted into and secured to the rear-terminal securing groove. Since the rear terminal can be housed in a position adjacent to the fitting chamber of the terminal accommodating groove and the front terminal can be housed in a position adjacent to the bottom surface of the terminal accommodating groove, it is possible to reduce the size of the multi-contact connector.

The rear extending portion may have distal-side rear securing bulges formed adjacent to the rear contact and secured to the housing, and proximal-side rear securing bulges formed adjacent to the substrate connecting portion. The distal-side rear securing bulges may be formed to be longer than the proximal-side rear securing bulges in the length direction of the rear extending portion.

In the rear terminal according to this aspect of the present invention, the rear extending portion is reliably secured to the housing at multiple points, that is, at the distal-side rear securing bulges and the proximal-side rear securing bulges. As described above, the distal-side rear securing bulges adjacent to the rear contact are formed to be longer than the proximal-side rear securing bulges in the length direction of the rear extending portion. Therefore, even when high contact pressure of the rear contact acts on the connection object, the distal-side rear securing bulges having a longer securing length firmly supports the proximal side of the rear contact which creates high contact pressure.

The multi-contact connector according to any aspect of the present invention not only achieves connection reliability by providing the function of wiping off foreign matter, but also reduces its overall size by independently and separately accommodating the front terminal and the rear terminal in one terminal accommodating groove.

### BRIEF DESCRIPTION OF THE DRAWINGS

FIG. 1 is a front view of a multi-contact connector according to an embodiment.

FIG. 2 is a plan view of FIG. 1.

FIG. 3 is a cross-sectional view taken along line in FIG. 1.

FIG. 4 is an external perspective view including a front view, a right side view, and a plan view of a front terminal and a rear terminal that form a signal multi-contact terminal illustrated in FIG. 1.

FIG. 5A is a front view of the front terminal and the rear terminal illustrated in FIG. 4, FIG. 5B is a right side view of the same, and FIG. 5C is a cross-sectional view of a soldering portion by which contact portions are soldered to a circuit contact point on a substrate.

FIG. 6 is an external perspective view including a front view, a right side view, and a plan view of a front terminal and a rear terminal that form a power multi-contact terminal illustrated in FIG. 1.

### DESCRIPTION OF THE PREFERRED EMBODIMENTS

Hereinafter, an embodiment of a multi-contact connector according to the present invention will be described with reference to the drawings. Throughout the present specification and claims, the width direction, the depth direction (front-rear direction), and the height direction (up-down direction) of the multi-contact connector may be referred to as the X direction, the Y direction, and the Z direction, respectively, for convenience of explanation, but they are not intended to limit how the multi-contact connector is mounted and used.

A multi-contact connector 1 includes a housing 2, a plurality of signal multi-contact terminals 3, a plurality of power multi-contact terminals 4, and a plurality of metal fasteners 5. The multi-contact connector 1 is mounted and secured by being soldered onto a substrate P. The multi-contact connector 1 thus electrically connects a connection object to a circuit on the substrate P. In the present embodiment, the multi-contact connector 1 is configured as a socket connector, and the “connection object” is a plug connector (hereinafter referred to as “target connector”). The “connection object” is not limited to a connector, such as a plug connector, and may be a flat conductor (e.g., hard substrate, flexible printed circuit (FPC), or flat flexible cable (FFC)) or a terminal (e.g., pin terminal).

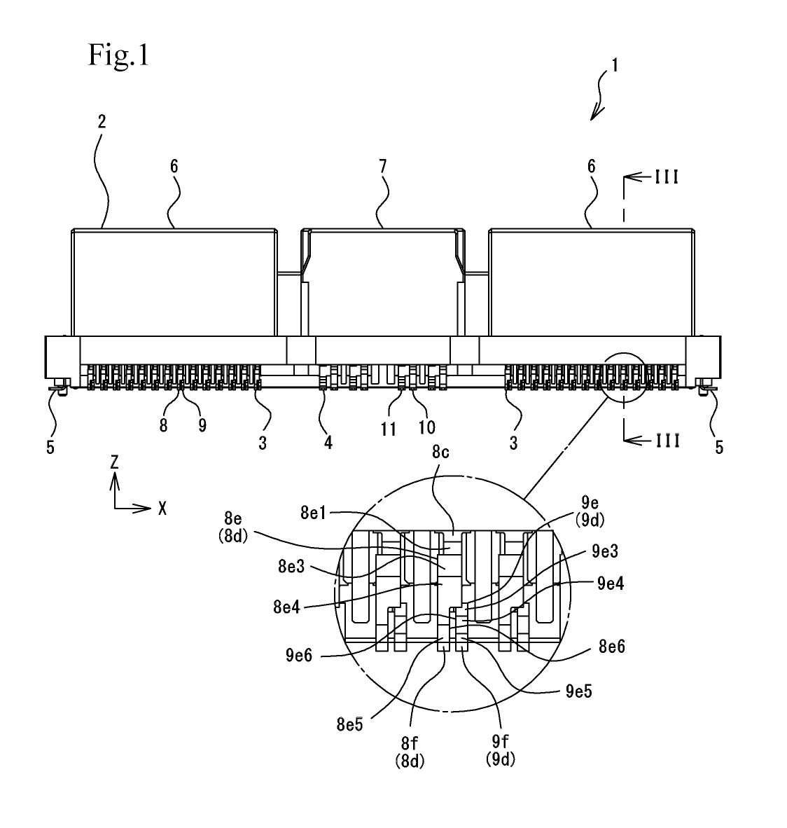

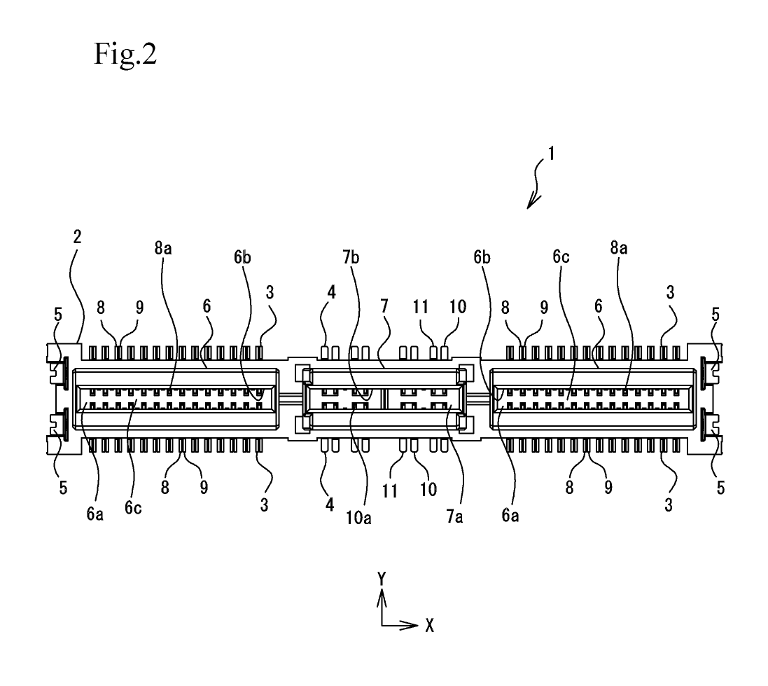

### Housing 2 (FIGS. 1 to 3)

The housing 2 is formed by a resin molded body, and includes signal connection units 6 on the right and left and a power connection unit 7 in the center.

The signal connection units 6 each include a plurality of signal multi-contact terminals 3 which are arranged side by side along the X direction in such a manner as to form two rows in the Y direction. Similarly, the power connection unit 7 includes a plurality of power multi-contact terminals 4 which are arranged side by side along the X direction in such a manner as to form two rows in the Y direction.

In the signal connection units 6 of the housing 2, a front terminal 8 and a rear terminal 9 forming each of the signal multi-contact terminals 3 are independently arranged without being in contact with each other. Similarly, in the power connection unit 7 of the housing 2, a front terminal 10 and a rear terminal 11 forming each of the power multi-contact terminals 4 are independently arranged without being in contact with each other. Unlike a terminal of the multi-contact connector of the related art, each terminal of the multi-contact connector 1 has no junction where it divides into a front contact and a rear contact. Accordingly, the housing 2 requires no space for accommodating such a junction, and this reduces the size of the multi-contact connector 1.

The signal connection units 6 each include a fitting chamber 6a, and the power connection unit 7 includes a fitting chamber 7a. The fitting chambers 6a and 7a are configured to allow a target connector 15 to be inserted and fitted thereinto and to be connected thereto. The fitting chamber 6a in each signal connection unit 6 and the fitting chamber 7a in the power connection unit 7 are structured in the same way, except for their dimensions. To avoid redundancy, the following description will deal with only one of the signal connection units 6.

The fitting chamber 6a in the signal connection unit 6 has an insertion port 6b for the target connector 15, and a bottom wall 6c located downstream of the insertion port 6b in the insertion direction (which is downward in the Z direction). The bottom wall 6c limits the insertion of the target connector 15.

The signal connection unit 6 has a plurality of terminal accommodating grooves 6d communicating with the fitting chamber 6a. The terminal accommodating grooves 6d have the same structure. The power connection unit 7 has a plurality of terminal accommodating grooves (not shown) having the same structure as the terminal accommodating grooves 6d. The terminal accommodating grooves in the power connection unit 7 are sized to fit the power multi-contact terminals 4.

Adjacent ones of the terminal accommodating grooves 6d are separated by partition walls 6e that protrude toward the fitting chamber 6a in the Y direction. Adjacent ones of the signal multi-contact terminals 3 are thus electrically insulated from each other. An internal space between the partition walls 6e facing each other is the fitting chamber 6a. The partition walls 6e form groove side surfaces along the depth direction of the terminal accommodating grooves 6d (i.e., Y direction).

The partition walls 6e each have a front-terminal securing groove 6f into which a front extending portion 8c (described below) of the front terminal 8 of each signal multi-contact terminal 3 is to be press-fitted, and a rear-terminal securing groove 6g into which a rear extending portion 9c (described below) of the rear terminal 9 of the signal multi-contact terminal 3 is to be press-fitted. The front-terminal securing groove 6f and the rear-terminal securing groove 6g extend in parallel along the Z direction. The front-terminal securing groove 6f and the rear-terminal securing groove 6g are formed in each of the partition walls 6e facing each other. The front terminal 8 and the rear terminal 9 are thus arranged in such a manner that the flat surface of the front extending portion 8c and the flat surface of the rear extending portion 9c extend along the width direction of the terminal accommodating groove 6d (i.e., X direction) and parallel to each other inside the terminal accommodating groove 6d. Thus, the multi-contact connector 1 can be made smaller in size than, for example, the multi-contact connector configured in such a manner that the flat surface of the front extending portion 8c and the flat surface of the rear extending portion 9c are accommodated side by side in their surface direction along the depth direction of the terminal accommodating groove 6d (i.e., Y direction) or along the width direction of the terminal accommodating groove 6d (i.e., X direction). Specifically, it is only necessary that the terminal accommodating groove 6d be configured to accommodate the thicknesses of the front extending portion 8c and the rear extending portion 9c parallel to each other. Therefore, the depth of the terminal accommodating groove 6d can be made shallower than that in the multi-contact connector of a comparative example where the flat surfaces of the front and rear extending portions are arranged side by side in the depth direction, and thus the housing 2 can be made smaller in size in the Y direction. At the same time, it is only necessary that the terminal accommodating groove 6d be configured to accommodate the larger of the widths of the front extending portion 8c and the rear extending portion 9c. Therefore, the width of the terminal accommodating groove 6d can be made narrower than that in the multi-contact connector of another comparative example where the flat surfaces of the front and rear extending portions are arranged side by side in the groove width direction, and thus the housing 2 can be made smaller in size in the X direction.

The front-terminal securing groove 6f is formed along a bottom surface 6h of the terminal accommodating groove 6d. The front terminal 8 is thus disposed in such a manner that one side of the front extending portion 8c faces the bottom surface 6h. Therefore, since the front contact 8a is not displaced beyond the front-terminal securing groove 6f toward the bottom surface 6h, the terminal accommodating groove 6d can be made shallow in the depth direction. The rear-terminal securing groove 6g is formed on the side of an opening 6i of the terminal accommodating groove 6d adjacent to the fitting chamber 6a. As in the case of the front terminal 8, the rear contact 9a and an elastic arm 9b of the rear terminal 9 are displaced toward the front terminal 8, and the rear extending portion 9c is not displaced beyond the rear-terminal securing groove 6g toward the front terminal 8. This minimizes the distance between the rear-terminal securing groove 6g and the front-terminal securing groove 6f, and makes the terminal accommodating groove 6d shallow in the depth direction.

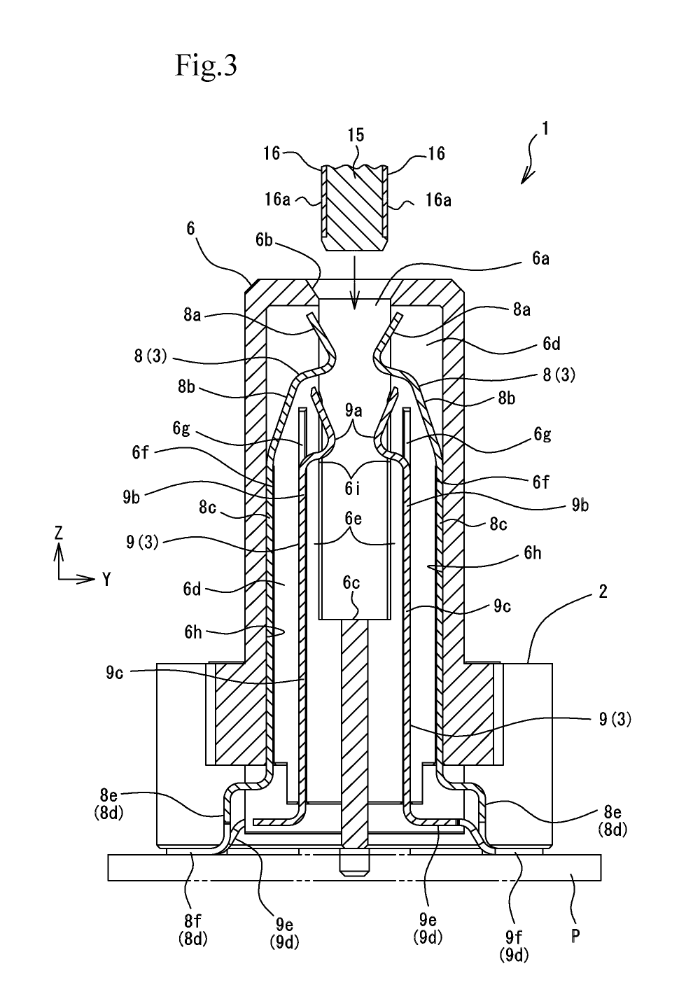

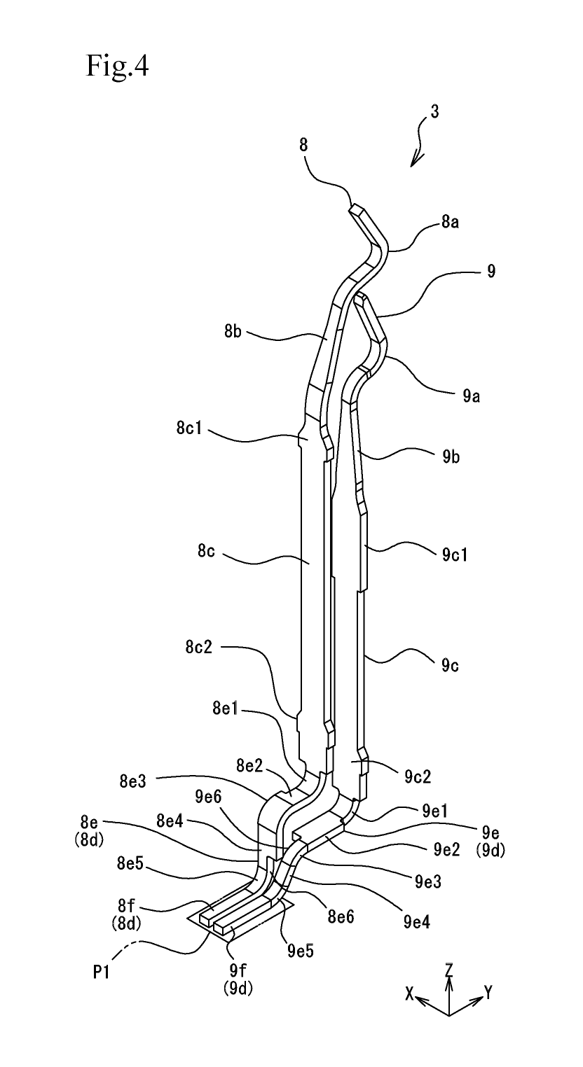

### Signal Multi-Contact Terminals 3 (FIGS. 3 to 5C)

The signal multi-contact terminals 3 are each configured as a terminal pair which is a combination of the front terminal 8 and the rear terminal 9. The front terminal 8 has the front contact 8a bent in a rounded V shape, and the rear terminal 9 has the rear contact 9a bent in a rounded V shape. The front contact 8a and the rear contact 9a each form a roll (or curved) surface that protrudes from the opening 6i of the terminal accommodating groove 6d toward the fitting chamber 6a. After the roll surface of the front contact 8a contacts a flat terminal surface 16a of the target terminal 16 of the target connector 15, the roll surface of the rear contact 9a located on a line extending from the front contact 8a in the insertion direction of the target connector 15 (i.e., Z direction) contacts the terminal surface 16a of the target terminal 16. Thus, since the rear contact 9a can contact the terminal surface 16a after the front contact 8a removes foreign matter (e.g., fibrous substrate debris, dirt, and dust) adhering to the terminal surface 16a, electrical conductivity is not impaired by foreign matter and this makes it possible to achieve a highly reliable electrical connection. Also, since the roll surfaces, instead of edges (cut faces), of the front contact 8a and the rear contact 9a contact the terminal surface 16a, plating on the terminal surface 16a is not damaged by the contact therewith.

The front terminal 8 has an elastic arm 8b that extends at an angle from the bottom surface 6h of the terminal accommodating groove 6d and connects to the proximal side of the front contact 8a. The elastic arm 8b serves as a spring piece which causes the front contact 8a to be displaced. A distal end of the front extending portion 8c disposed along the bottom surface 6h connects to the proximal side of the elastic arm 8b.

The front extending portion 8c is in the shape of a flat plate, and has distal-side front securing bulges 8c1 and proximal-side front securing bulges 8c2 on both sides thereof. The front extending portion 8c is thus secured to the front-terminal securing groove 6f at two points which are spaced apart in the length direction. Therefore, the front terminal 8 is prevented from being accidentally rotated even when being pressed into contact with the target connector 15. The front terminal 8 is thus reliably secured to the housing 2. The front extending portion 8c has a narrower width at the position of the distal-side front securing bulges 8c1 than at the position of the proximal-side front securing bulges 8c2. Accordingly, the front-terminal securing groove 6f is formed to be narrower at the position where the distal-side front securing bulges 8c1 are sandwiched than at the position where the proximal-side front securing bulges 8c2 are sandwiched. Thus, since there is no need to press-fit the distal-side front securing bulges 8c1 at the beginning of insertion into the front-terminal securing groove 6f, the front terminal 8 can be smoothly press-fitted into the front-terminal securing groove 6f.

A crank-shaped substrate connecting portion 8d is formed on the proximal side of the front extending portion 8c. The substrate connecting portion 8d includes a leg 8e and a contact portion 8f soldered to the substrate P. The leg 8e includes an upper bent portion 8e1, a horizontal piece 8e2, an intermediate bent portion 8e3, a vertical piece 8e4, and a lower bent portion 8e5 that connects to the contact portion 8f. An edge of the leg 8e adjacent to the rear terminal 9 has a recess 8e6 which extends from the middle of the vertical piece 8e4 to the proximal end of the lower bent portion 8e5 to reduce the width of the leg 8e. The leg 8e has the same width as the contact portion 8f in the region having the recess 8e6.

The rear terminal 9 has the elastic arm 9b which connects to the proximal side of the rear contact 9a bent in a rounded V shape. The proximal side of the elastic arm 9b connects to the rear extending portion 9c.

The rear extending portion 9c is formed in the shape of a flat plate, and has distal-side rear securing bulges 9c1 and proximal-side rear securing bulges 9c2 on both sides thereof. The rear extending portion 9c is secured to the rear-terminal securing groove 6g at the distal-side rear securing bulges 9c1 and the proximal-side rear securing bulges 9c2 which are spaced apart in the length direction of the rear extending portion 9c. Therefore, the rear terminal 9 is prevented from being accidentally rotated even when being pressed into contact with the target connector 15. The rear terminal 9 is thus reliably secured to the housing 2. The rear extending portion 9c has a narrower width at the position of the distal-side rear securing bulges 9c1 than at the position of the proximal-side rear securing bulges 9c2. Thus, as in the case of the front terminal 8, the rear terminal 9 can be smoothly press-fitted into the rear-terminal securing groove 6g.

The distal-side rear securing bulges 9c1 are formed to be longer than the proximal-side rear securing bulges 9c2 in the length direction of the rear extending portion 9c. Therefore, even when the contact pressure of the rear contact 9a against the target connector 15 is set high, the distal-side rear securing bulges 9c1 having a long press-fit securing length can firmly support the proximal side of the rear contact 9a, which creates high contact pressure, without causing the rear-terminal securing groove 6g to break.

A crank-shaped substrate connecting portion 9d is formed on the proximal side of the rear extending portion 9c. The substrate connecting portion 9d includes a leg 9e and a contact portion 9f soldered to the substrate P. The leg 9e includes an upper bent portion 9e1, a horizontal piece 9e2, an intermediate bent portion 9e3, an inclined piece 9e4, and a lower bent portion 9e5 that connects to the contact portion 9f. An edge of the leg 9e adjacent to the front terminal 8 has a recess 9e6 which extends from the distal end of the intermediate bent portion 9e3 to the proximal end of the lower bent portion 9e5 to reduce the width of the leg 9e. The leg 9e has the same width as the contact portion 9f in the region having the recess 9e6.

The recess 9e6 and the recess 8e6, by which the leg 9e and the leg 8e are narrowed in width, define a gap between the rear terminal 9 and the front terminal 8. The inclined piece 9e4 of the leg 9e of the rear terminal 9 extends in such a manner as to pass below the leg 8e of the front terminal 8 (i.e., below an edge of the vertical piece 8e4 which defines the recess 8e6 and extends along the width direction of the front terminal 8), and the lower bent portion 9e5 and the contact portion 9f running from the inclined piece 9e4 extend parallel to the lower bent portion 8e5 and the contact portion 8f of the front terminal 8. That is, the legs 8e and 9e have the recesses 8e6 and 9e6 in the region where their surfaces would overlap if they were arranged in parallel. In other words, the recesses 8e6 and 9e6 are provided to avoid widening of the substrate connecting portions 8d and 9d. The substrate connecting portions 8d and 9d are arranged in parallel only at the lower bent portion 8e5 of the leg 8e and the contact portions 8f and the lower bent portion 9e5 of the leg 9e and the contact portion 9f. This allows the signal multi-contact terminals 3 to be arranged at smaller pitches, and reduces the size of the multi-contact connector 1 in the X direction.

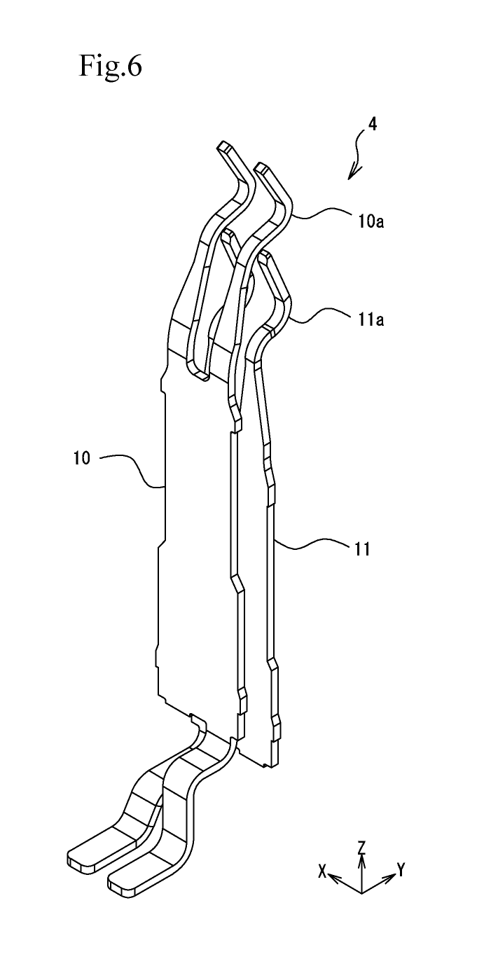

### Power Multi-Contact Terminals 4 (FIG. 6)

The power multi-contact terminals 4 have basically the same configuration as the signal multi-contact terminals 3 and redundant explanations will be omitted. The power multi-contact terminals 4 differ from the signal multi-contact terminals 3 in that a front contact 10a of the front terminal 10 and a rear contact 11a of the rear terminal 11 are each bifurcated into two parts. The front contact 10a and the rear contact 11a having a bifurcated shape allow a large current to flow through. Also, even if one of the two parts of the bifurcated contact fails to make contact with the target connector 15, the other can successfully make contact therewith, and this improves reliability of electrical contact.

### Use of Multi-Contact Connector 1

The multi-contact connector 1 configured as described above is electrically connected and secured to the circuit on the substrate P by being soldered, to the substrate P, at the contact portions 8f and 9f of the signal multi-contact terminals 3, the contact portions of the power multi-contact terminal 4, and metal fasteners 5 on both sides of the housing 2 in the X direction.

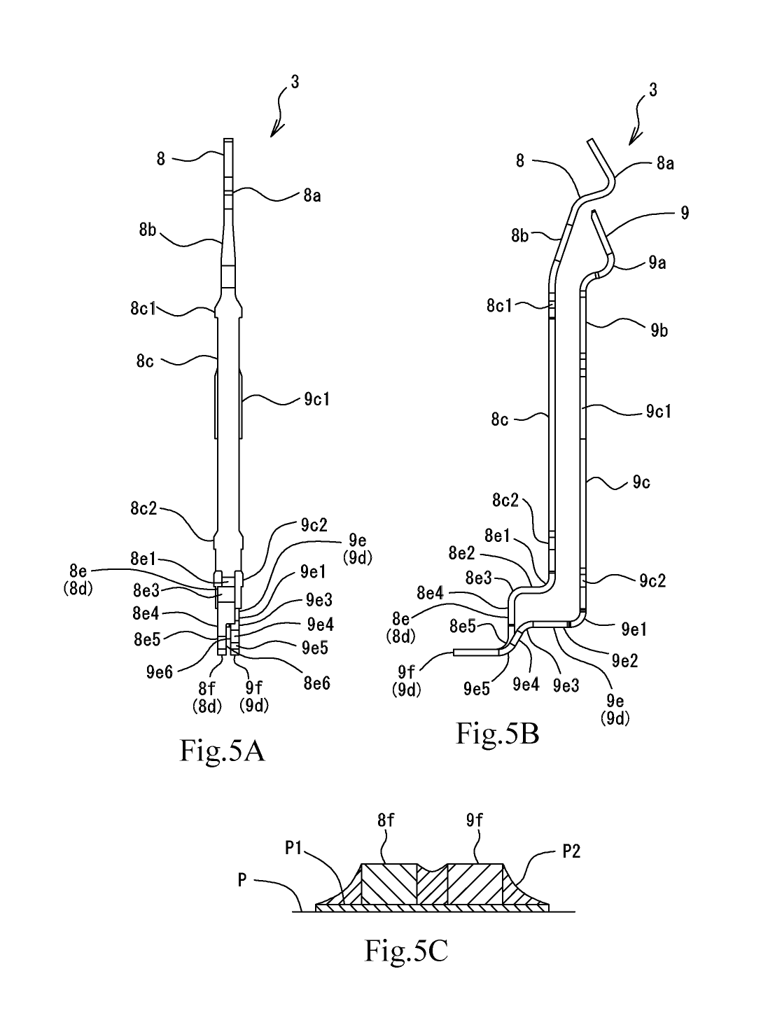

As illustrated in FIG. 5C, the contact portion 8f of the front terminal 8 and the contact portion 9f of the rear terminal 9 are electrically connected by a soldering portion P2 to one circuit contact point P1 on the substrate P. Therefore, even if one of the contact portions 8f and 9f of the front and rear terminals 8 and 9 fails to make electrical contact with the circuit contact point P1, the other can maintain the electrical connection and this makes it possible to maintain high connection reliability. Also, since the contact portions 8f and 9f are soldered together to one circuit contact point P1, the peeling strength of the soldering portion P2 is improved.

When the target connector 15 is inserted through the insertion ports 6b and 7b into the fitting chambers 6a and 7a of the housing 2, the terminal surfaces 16a of the target terminals 16 contact the front contacts 8a of the front terminals 8 and then the rear contacts 9a of the rear terminals 9. Since the front contacts 8a keep sliding contact with the terminal surfaces 16a during this operation, the front contacts 8a can wipe off and remove foreign matter adhering to the terminal surfaces 16a. This improves contact reliability of at least the rear contacts 9a.

As described above, the front terminal 8 and the rear terminal 9 forming a pair are independently and separately arranged in one terminal accommodating groove 6d having the same width as the front terminal 8 and the rear terminal 9. Therefore, while the multi-contact connector 1 has a wiping mechanism realized by the multi-contact terminals 3 and 4, the overall size of the multi-contact connector 1 is reduced.

Ideally, the target connector 15 is inserted in a straight line into the fitting chambers 6a and 7a. However, the target connector 15 is often inserted at an angle into the fitting chambers 6a and 7a, and insertion forces from various directions act on the multi-contact connector 1. If the legs 8e of the front terminals 8 and the legs 9e of the rear terminals 9 have the same shape, all the legs 8e and 9e deform in the same way and this makes it difficult to accommodate the insertion forces from various directions. This may result in concentration of stress on the soldering portions P2 and may produce defects, such as cracks.

In the multi-contact connector 1 of the present embodiment, however, the legs 8e and 9e of the front and rear terminals 8 and 9 forming a pair are configured to partly extend in different directions. Specifically, the rear terminal 9 includes the inclined piece 9e4, which is absent in the leg 8e of the front terminal 8. Therefore, even if the target connector 15 is inserted in the housing 2 at an angle, the housing 2 can be supported by at least one of the legs 8e and 9e, which partly extend in different directions. This relieves the concentration of stress on the soldering portions P2, and the insertion forces from various directions can be accommodated by the legs 8e and 9e.

What is claimed is:

1. A multi-contact connector comprising:
a housing having a fitting chamber into which a connection object is to be inserted;
a front terminal including a flat plate-shaped front extending portion held by the housing, and a front contact configured to contact the connection object inserted into the fitting chamber; and
a rear terminal including a flat plate-shaped rear extending portion held by the housing, and a rear contact located on a line extending from the front contact in an insertion direction of the connection object,
wherein the housing has one terminal accommodating groove communicating with the fitting chamber and configured to accommodate the front terminal and the rear terminal together in such a manner that the front terminal and the rear terminal are in a separate state; and
the front terminal and the rear terminal include respective substrate connecting portions extending from the terminal accommodating groove and electrically connected to one circuit contact point on a substrate.

2. The multi-contact connector according to claim 1, wherein the substrate connecting portion of the front terminal and the substrate connecting portion of the rear terminal each include a contact portion soldered to the circuit contact point and a leg extending from the terminal accommodating groove to the contact portion, the leg of the front terminal and the leg of the rear terminal partly extending in directions different from each other.

3. The multi-contact connector according to claim 1, wherein the terminal accommodating groove is configured to accommodate the front terminal and the rear terminal in such a manner that a flat surface of the front extending portion and a flat surface of the rear extending portion extend along a width direction of the terminal accommodating groove and face each other.

4. The multi-contact connector according to claim 1, wherein the terminal accommodating groove has
a rear-terminal securing groove disposed adjacent to an opening of the terminal accommodating groove communicating with the fitting chamber, the rear-terminal securing groove being configured to allow the rear extending portion to be press-fitted thereinto in such a manner that a surface of the rear extending portion extends along a width direction of the terminal accommodating groove; and
a front-terminal securing groove disposed closer to a bottom surface of the terminal accommodating groove than the rear-terminal securing groove is, the front-terminal securing groove being configured to allow the front extending portion to be press-fitted thereinto in such a manner that a surface of the front extending portion extends along the width direction of the terminal accommodating groove.
